(19) United States
(12) Patent Application Publication
(10) Pub. No.: US 2026/0276845 A1
(43) Pub. Date: Sep. 17, 2026

(54) EVENT-BY-EVENT ENERGY-BASED SCATTER ESTIMATION

(71) Applicant: Siemens Medical Solutions USA, Inc., Malvern, PA (US)

(72) Inventor: James Hamill, Knoxville, TN (US)

(21) Appl. No.: 19/076,366

(22) Filed: Mar. 11, 2025

(51) Int. Cl. G01T 1/29; G01T 7/00; G06T 11/00

(52) U.S. Cl. CPC G01T 1/2985; G01T 7/005; G06T 12/10; G06T 2210/41

(57) ABSTRACT

A framework for event-by-event energy-based scatter estimation. The framework acquires coincidence event data of a target region. The coincidence event data records energy signal data associated with scintillation crystals of a positron emission tomographic (PET) scanner. Scatter content associated with each coincidence event in the coincidence event data may then be estimated.

### TECHNICAL FIELD

The present disclosure generally relates to nuclear imaging, and more particularly, to event-by-event energy-based scatter estimation in image data.

### BACKGROUND

The field of medical imaging has seen significant advances since the time X-Rays were first used to see the inside of the human body. Nuclear medicine and molecular imaging is a type of medical imaging that is used to visualize how the body is functioning. In nuclear medicine and molecular imaging procedures, a radioactive tracer is introduced into the body, where it gets incorporated in a specific tissue, organ or process and is then detected by an external device to provide information on the function of tissues and organs.

One particular nuclear medicine imaging technique is Positron Emission Tomography (PET). PET is used to produce images for diagnosing the biochemistry or physiology of a specific organ, tumor or other metabolically active site. Measurement of the tissue concentration of a positron emitting radionuclide is based on coincidence detection of the two gamma photons arising from positron annihilation. When a positron is annihilated by an electron, two 511 keV gamma photons are simultaneously produced and travel in approximately opposite directions. Gamma photons produced by an annihilation event can be detected by a pair of oppositely disposed radiation detectors capable of producing a signal in response to the interaction of the gamma photons with a scintillation crystal. Annihilation events are typically identified by a time coincidence between the detection of the two 511 keV gamma photons in the two oppositely disposed detectors, i.e., the gamma photon emissions are detected virtually simultaneously by each detector. When two oppositely disposed gamma photons each strike an oppositely disposed detector to produce a time coincidence event, they also identify a line of response (LOR) along which the annihilation event has occurred. After being integrated and sorted into LORs defined by the positions of the detectors in the PET camera, the coincidence event data is used to reconstruct a three-dimensional distribution of the positron-emitting radionuclide within the patient.

Annihilation photons may undergo Compton scattering (or Klein-Nishina scattering) of 511-keV annihilation photons, resulting in photons with energy below 511 keV (i.e., energy loss). Such scattered events may represent a large portion of the measured data (e.g., up to 50% or more in clinical studies). Techniques to correct for such scatter in PET image reconstruction include single scatter simulation (SSS) algorithms and energy-based scatter estimation (EBS) algorithms.

However, current scatter correction methods using primarily SSS algorithms to correct PET scan data for scatter effects have some room for improvement. For example, SSS methods require sinograms, attenuation maps and long computation time. Attenuation correction data is commonly acquired by computed tomographic (CT) scan performed before the PET scan. Thus, there is a time delay between the acquisition of the CT scan data used to estimate the scatter effects and the acquisition of the PET scan data.

EBS is based on digitized one-dimensional or two-dimensional (2D) energy histograms in each bin of a coarsely sampled PET sinogram, either with or without time of flight (TOF). EBS methods perform well in modern PET scanners and can give images that are qualitatively and quantitatively similar to images based on SSS, for example whole-body oncological PET. However, traditional EBS methods underestimate scatter in some PET scans. Additionally, estimated scatter sinograms from traditional EBS methods exhibit spatial variations or noise. This is because EBS is based on a relatively small number of coincidence pairs in individual sinogram bins.

### SUMMARY

Described herein is a framework for event-by-event energy-based scatter estimation. The framework acquires coincidence event data of a target region. The coincidence event data records energy signal data associated with scintillation crystals of a PET scanner. Scatter content associated with each coincidence event in the coincidence event data may then be estimated.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 is a block diagram illustrating an exemplary system;

FIG. 2 shows an exemplary method of scatter estimation;

FIG. 3 shows an exemplary calibration procedure;

FIG. 4a shows an exemplary algorithm for performing the Gram-Schmidt (GS) orthogonalization procedure;

FIG. 4b shows exemplary graphs of one-dimensional (1D) basis functions and corresponding GS functions;

FIG. 4c shows exemplary two-dimensional (2D) basis functions and corresponding GS functions;

FIG. 5 shows an exemplary algorithm for sorting the list-mode PET scan data into a time-of-flight (TOF) sinogram;

FIG. 6 shows an exemplary grayscale image that represents one-photon scatter estimate values; and

FIG. 7 illustrates results obtained by an exemplary one-dimensional (1D) scatter estimation model.

### DETAILED DESCRIPTION

In the following description, numerous specific details are set forth such as examples of specific components, devices, methods, etc., in order to provide a thorough understanding of implementations of the present framework. It will be apparent, however, to one skilled in the art that these specific details need not be employed to practice implementations of the present framework. In other instances, well-known materials or methods have not been described in detail in order to avoid unnecessarily obscuring implementations of the present framework. While the present framework is susceptible to various modifications and alternative forms, specific embodiments thereof are shown by way of example in the drawings and will herein be described in detail. It should be understood, however, that there is no intent to limit the invention to the particular forms disclosed; on the contrary, the intention is to cover all modifications, equivalents, and alternatives falling within the spirit and scope of the invention. Furthermore, for ease of understanding, certain method steps are delineated as separate steps; however, these separately delineated steps should not be construed as necessarily order dependent in their performance.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and interface to a variety of operating systems. In addition, implementations of the present framework are not described with reference to any particular programming language. It will be appreciated that a variety of programming languages may be used.

As used herein, the term “image” refers to multi-dimensional data composed of discrete image elements (e.g., pixels for 2D images and voxels for 3D images). The image may be, for example, a medical image of a subject collected by computer tomography, magnetic resonance imaging, ultrasound, or any other medical imaging system known to one skilled in the art. The image may also be provided from non-medical contexts, such as, for example, remote sensing systems, electron microscopy, etc. Although an image can be thought of as a function from R³ to R, or a mapping to R³, the present methods are not limited to such image and can be applied to images of any dimension, e.g., a 2D picture or a 3D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

One aspect of the present framework provides a linear event-by-event energy-based scatter estimation (EBS) method. In some implementations, the event-by-event EBS method includes pre-calculating scatter content using orthogonal basis functions based on calibration scan data. Scatter content in PET coincidence event data (e.g., list-mode scan data) may be estimated by looking up the pre-calculated scatter content. A further smoothing step may be performed to reduce noise in the scatter estimate. The scatter estimate may then be recorded in a data set that can be used to reconstruct PET images more accurately.

Unlike previous SSS methods, the present event-by-event EBS method does not require attenuation maps. Unlike previous EBS methods that use an iterative algorithm, the present EBS method is a linear algorithm that rearranges the computations so that scatter is pre-calculated based only on energies of the photons, so that the scatter estimation may be performed when the coincidence event data (or list-mode data) is first processed. The present event-by-event EBS method enables faster computation and simplified data flow. Faster computation is the result of a simplified algorithm and pre-calculation of the solution. Simplified data flow is the result of eliminating steps of down-sampling and up-sampling in the present approach. These and other exemplary features and advantages will be described in more detail herein.

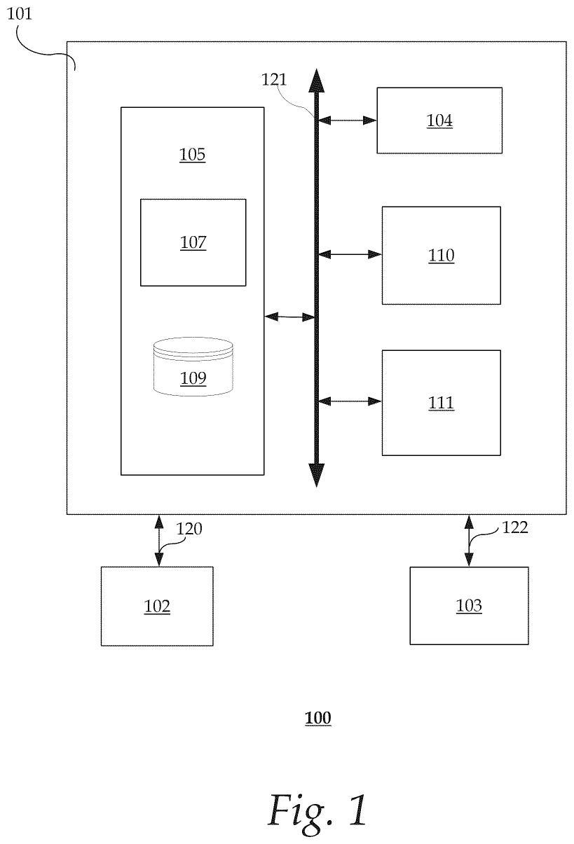

FIG. 1 is a block diagram illustrating an exemplary system 100. System 100 includes a computer system 101 for implementing the framework as described herein. In some implementations, computer system 101 operates as a standalone device. In other implementations, computer system 101 may be connected (e.g., using a network) to other machines, such as PET scanner 102 and workstation 103. In a networked deployment, computer system 101 may operate in the capacity of a server (e.g., thin-client server), a cloud computing platform, a client user machine in server-client user network environment, or as a peer machine in a peer-to-peer (or distributed) network environment.

In some implementations, computer system 101 comprises a processor or central processing unit (CPU) 104 coupled to one or more non-transitory computer-readable media 105 (e.g., computer storage or memory device), a display device 110 (e.g., monitor) and various input devices 111 (e.g., mouse or keyboard) via an input-output interface 121. Computer system 101 may further include support circuits such as a cache, a power supply, clock circuits and a communications bus. Various other peripheral devices, such as additional data storage devices and printing devices, may also be connected to the computer system 101.

The present technology may be implemented in various forms of hardware, software, firmware, special purpose processors, or a combination thereof, either as part of the microinstruction code or as part of an application program or software product, or a combination thereof, which is executed via the operating system. In some implementations, the techniques described herein are implemented as computer-readable program code tangibly embodied in non-transitory computer-readable media 105. In particular, the present techniques may be implemented by a processing module 107.

Non-transitory computer-readable media 105 may include random access memory (RAM), read-only memory (ROM), flash memory, and other types of memories, or a combination thereof. The computer-readable program code is executed by CPU 104 to process data retrieved from, for example, medical device 120, workstation 103 and database 109. As such, computer system 101 is a general-purpose computer system that becomes a specific-purpose computer system when executing the computer-readable program code. The computer-readable program code is not intended to be limited to any particular programming language and implementation thereof. It will be appreciated that a variety of programming languages and coding thereof may be used to implement the teachings of the disclosure contained herein.

The same or different computer-readable media 105 may be used for storing a database (or dataset) 109. Such data may also be stored in external storage or other memories. The external storage may be implemented using a database management system (DBMS) managed by the CPU 104 and residing on a memory, such as a hard disk, RAM, or removable media. The external storage may be implemented on one or more additional computer systems. For example, the external storage may include a data warehouse system residing on a separate computer system, a cloud platform or system, a picture archiving and communication system (PACS), or any other hospital, medical institution, medical office, testing facility, pharmacy or other medical patient record storage system.

Workstation 103 may include a tablet, mobile device, laptop or computer intended to be used by the medical technician. Workstation 103 may include a graphical user interface to receive user input via an input device (e.g., keyboard, mouse, touch screen, voice or video recognition interface) to input medical data 122. Workstation 103 can be operated in conjunction with the entire system 100. For example, workstation 103 may communicate directly or indirectly with Positron emission tomography (PET) scanner 102. PET scanner 102 is a radiological scanner that acquires PET image data 120, such as medical image data of patients or clinical subjects.

It is to be further understood that, because some of the constituent system components and method steps depicted in the accompanying figures can be implemented in software, the actual connections between the system components (or the process steps) may differ depending upon the manner in which the present framework is programmed. Given the teachings provided herein, one of ordinary skill in the related art will be able to contemplate these and similar implementations or configurations of the present framework.

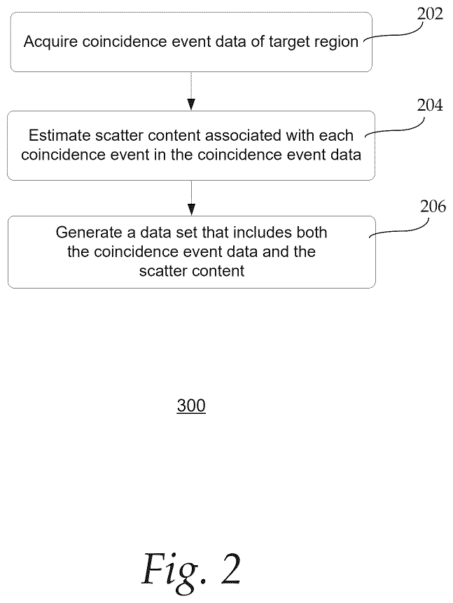

FIG. 2 shows an exemplary method 200 of scatter estimation. It should be understood that the steps of the method 200 may be performed in the order shown or a different order. Additional, different, or fewer steps may also be provided. Further, the method 200 may be implemented with the system 100 of FIG. 1, a different system, or a combination thereof.

At 202, processing module 107 acquires coincidence event data of a target region. The target region may be, for example, patient tissue region or any other region of interest. The coincidence event data records energy signal data associated with scintillation crystals of PET scanner 102. The coincidence event data may be, for example, list-mode PET scan data, which generally refers to raw data recorded during a PET scan by, for example, the PET scanner 102. In some implementations, the coincidence event data may record first and second energy signal data corresponding to first and second scintillation crystals in the PET scanner 102. For example, the coincidence event data may record event-by-event data (e.g., energy signals, time of flight, spatial locations) of all coincidence gamma events or coincidences detected by, for example, “A” and “B” scintillation crystals in the PET scanner 102.

More particularly, the energy signals in the PET list-mode data are quantified by a histogram. A one-dimensional (1D) energy histogram may be represented by n(i_{E}), while a two-dimensional (2D) energy histogram may be represented by n(i_{EA},i_{EB}), i.e., A crystal vs. B crystal energy histogram. This can be associated with any collection of coincidence detector pairs, for example, one A crystal and one B crystal, or a collection of 100 A crystals and 100 B crystals.

At 204, processing module 107 estimates scatter content associated with each coincidence event in the coincidence event data. In some implementations, the scatter content is extracted from a set of pre-calculated scatter content values. The set of pre-calculated scatter content values may be stored in a look-up table or other suitable data structure, and retrieved using only the energy signal data.

The set of scatter content values may be pre-calculated using orthogonal basis functions. Orthogonal basis functions generally refer to a set of functions {g(x)} that satisfy the orthogonality condition with respect to an inner product defined on a function space. In other words, two functions gᵢ(x) and gⱼ(x) are orthogonal if their inner product is zero. The orthogonal basis functions may be determined during a calibration procedure performed before acquisition of the coincidence event data of the target region. Such calibration procedure may be performed at pre-determined times (e.g., once a day, weekly or monthly). The orthogonal basis functions and scatter content values obtained from the calibration procedure may be re-used for subsequent PET scans of the target region or a different target region (e.g., different patient) without performing another calibration.

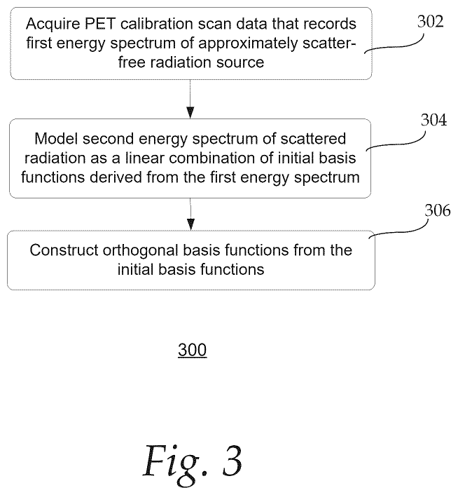

FIG. 3 shows an exemplary calibration procedure 300. It should be understood that the steps of the calibration procedure 300 may be performed in the order shown or a different order. Additional, different, or fewer steps may also be provided. Further, the procedure 300 may be implemented with the system 100 of FIG. 1, a different system, or a combination thereof.

At 302, processing module 107 receives PET calibration scan data. The PET calibration scan data records a first energy spectrum of an approximately scatter-free radiation source. The radiation source may be, for example, a small and lightweight phantom (e.g., line source phantom) that contains radioactivity and stops emitted positrons while scattering very little of the resulting annihilation radiation and producing approximately scatter-free radiation.

PET scanner 102 may be used to acquire PET calibration scan data of the radiation source. It should be appreciated that the PET scanner used to acquire the calibration scan data may be the same or different from the PET scanner used to acquire coincidence event data of the target region. The emitted radiation from the source is expected to scatter minimal number of photons. This provides list-mode data containing the first energy spectrum of a known radiation source and functions as a fingerprint of the particular PET scanner's 102 detectors, since list-mode data will not be tainted with scatter effects. The first energy spectrum of scatter-free radiation may be quantified based on the PET calibration scan data as histograms (e.g., two-dimensional histograms).

In some implementations, background energy data is acquired by performing a PET scan without any radiation source in the field of view of the PET scanner. For example, a 2-hour scan may be taken without any radiation source in the field of view. The energy levels acquired during this background measurement will be largely due to beta decays of scintillation crystals (e.g., lutetium oxyorthosilicate or LSO) in the PET scanner detector.

At 304, processing module 107 models a second energy spectrum of scattered radiation as a linear combination of initial basis functions derived from the first energy spectrum. For purposes of illustration, a one-dimensional (1D) energy spectrum is discussed. This may be extended to a two-dimensional case, as will be described later. The 1D energy spectrum is seen by only one detector or group of detectors of the PET scanner. The total number (n) of detected photons in the second energy spectrum may be modeled as follows:

$$n = {\sum }_{{i}_{E}} n ( {i}_{E} ) \qquad ( 1 )$$

wherein estimates of how many photons have scattered are based on the fact that the measurement is further subdivided into energy bins, with n(i_{E}) counts in distinct energy bins. The letters i_{E} denote a bin or array location that stores all energy signal values in a particular energy range after conversion by an analog-to-digital converter (ADC), and the distribution of energies is approximated by the set of all energy bins in the list-mode data. As an example, a PET scanner may record energy signal in 54 energy bins evenly distributed between 435 keV and 585 keV, each bin corresponding to the energy determined by the ADC which differs from the photons' actual energies due to limitations in the PET detectors' energy resolution. It should be appreciated that other number of energy bins are also possible.

The expected counts \hat{n}(i_{E}) of the second energy spectrum of scattered radiation may be modeled as the following linear combination of initial basis functions:

$$\hat{n} ( {i}_{E} ) = {a}_{0} {p}_{0} ( {i}_{E} ) + {a}_{1} {p}_{1} ( {i}_{E} ) + {a}_{2} {p}_{2} ( {i}_{E} ) + … \qquad ( 2 )$$

wherein a₀, a₁, a₂, . . . represent coefficients, p₀ basis function represents the first energy spectrum of scatter-free radiation, p₁ basis function represents small-angle scatter, and p₂ basis function represents scatter through larger angles. Additional initial basis functions (e.g., p₃, p₄, p₅) may be provided to model scatter through successively larger angles.

The basis function p₀(i_{E}) may be directly extracted from a measurement of the average energy spectrum of all detectors obtained from the approximately scatter-free source (or phantom) during the calibration scan. The p₁ (i_{E}) basis function may be determined by selecting a sinogram region representing small-angle scatter in the case of a line source phantom, and determining a smooth function ƒ(i_{E}) that closely fits the first energy spectrum in this case, using the shape p₁(i_{E})=p₀ƒ(i_{E}).

Successive basis functions p₂ (i_{E}), p₃(i_{E}), and p₄(i_{E}) may then be derived by: first, creating simplified basis functions of energy that do not include the energy resolution and then calculating the actual basis functions p₁, p₂, etc. that do include the energy resolution, as the cross-correlation of the simplified basis function with the first energy spectrum of scatter-free radiation. The successive basis functions may be determined by shifting p₁ (i_{E}) downward in energy by successively larger amounts. The last basis function, p₅ (i_{E}) represents the background energy data detected by the detectors when no radiation source is present in the field of view. This background measurement may be taken during a calibration scan procedure.

In the case of two-dimensional energy spectrum used in actual PET scans, equations (1) and (2) may be re-written as follows:

$$n ( d ) = {\sum }_{{i}_{EA} , {i}_{EB}} n ( {i}_{EA} , {i}_{EB} ; d ) \qquad ( 3 )$$

$$\hat{n} ( {i}_{EA} , {i}_{EB} ; d ) = \sum {a}_{{k}_{A} {k}_{B}} {p}_{{k}_{A} {k}_{B}} ( {i}_{EA} , {i}_{EB} ; d ) \qquad ( 4 )$$

Counts are in a particular TOF sinogram bin, d. 2D basis functions are indexed by k_{A} and k_{B} and have indices for the A and B detectors, a space in which the number of measurement bins may be, for example, 54×54=2916. The 2D basis functions are as follows:

$${p}_{{k}_{A} {k}_{B}} ( {i}_{EA} , {i}_{EB} ) = {p}_{{k}_{A}} ( {i}_{EA} ) {p}_{{k}_{B}} ( {i}_{EB} ) \qquad ( 5 )$$

At 306, processing module 107 constructs orthogonal basis functions from the initial basis functions. The orthogonal basis functions are mutually orthogonal to each other and normalized to facilitate solving systems of linear equations. In linear EBS, we recognize that measured values n(i_{EA}, i_{EB}) define a vector in the space with, for example, 54×54=2916 energy bins. In a computer implementation, a vector may simply be an array that stores the measured values. Each basis function also defines a vector in that space. An inner product of two vectors (ƒ₁, ƒ₂) may be defined as follows:

$$〈 {f}_{1} , {f}_{2} 〉 = {\sum }_{{i}_{EA} , {i}_{EB}} {f}_{1} ( {i}_{EA} , {i}_{EB} ) {f}_{2} ( {i}_{EA} , {i}_{EB} ) \qquad ( 6 )$$

In some implementations, the orthogonalization algorithm used to construct the orthonormal second basis functions include the Gram-Schmidt (GS) orthogonalization procedure. It should be appreciated that other types of orthogonalization algorithms may also be used.

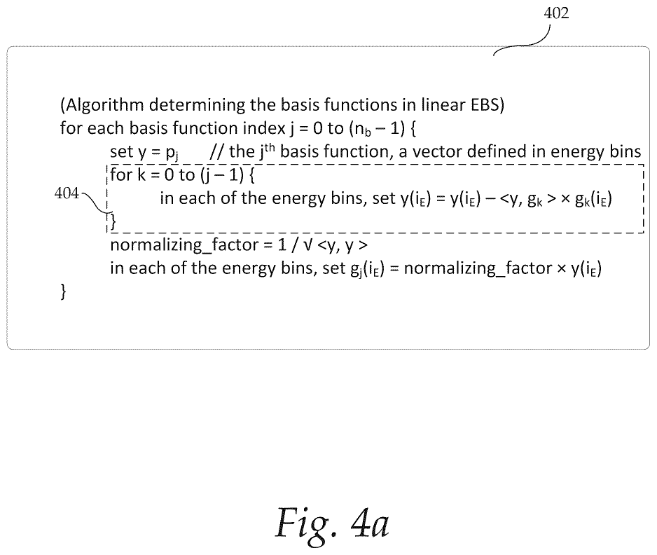

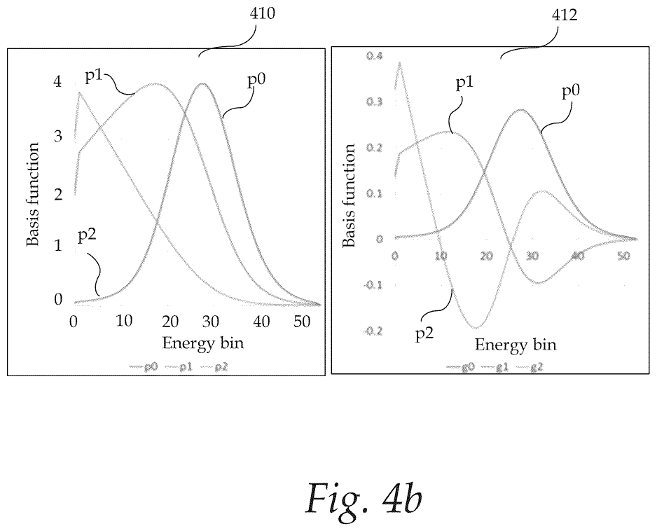

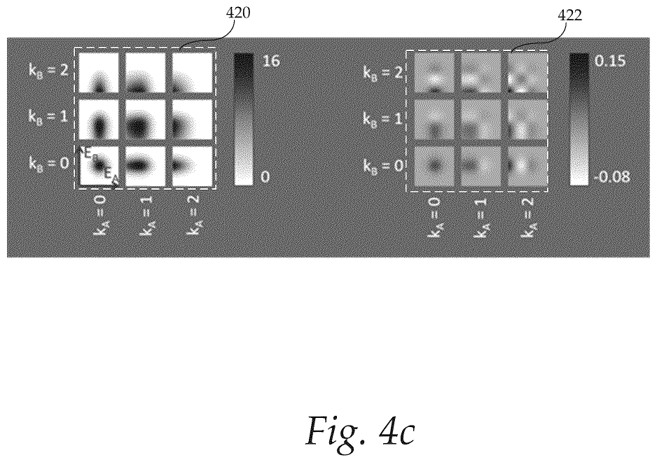

FIG. 4a shows an exemplary algorithm 402 for performing the Gram-Schmidt (GS) orthogonalization procedure. The Gram-Schmidt (GS) orthogonalization procedure may be performed only once to generate orthonormal basis functions gᵢ from the initial basis functions pᵢ. The first GS basis function, g₀, is a normalized version of initial basis function p₀. The second GS basis function, g₁, is formed by subtracting the part of p₁ that is parallel to p₀, then normalizing the result. Other basis functions gᵢ are formed similarly. Each GS basis function, gⱼ(i_{E}), is unit-normalized, i.e. the sum of all gⱼ(i_{E}) values is 1 for each index j. The “k” loop 404 in algorithm 402 is not used for index j=0.

FIG. 4b shows exemplary graphs (410 and 412) of one-dimensional (1D) basis functions and corresponding GS functions. More particularly, graph 310 plots one-dimensional basis functions p₀, p₁ and p₂, and graph 312 shows the corresponding GS functions, g₀, g₁ and g₂. The discretized energy range has 54 energy bins for the range from 435 keV to 585 keV.

Linear event-by-event EBS in two dimensions is a straightforward extension of the 1D case. Each basis function pₖ_{_{A}}ₖ_{_{B}} (i_{EA}, i_{EB}) has a corresponding Gram-Schmidt function gₖ_{_{A}}ₖ_{_{B}}(i_{EA}, i_{EB}), defined by algorithm 302 above except that, when there are three 1D basis functions in 1D, there are 3×3=9 basis functions in 2D.

FIG. 4c shows exemplary 2D basis functions 420 and corresponding GS functions 422. Grayscale images are used to illustrate the 2D basis functions 420 that are neither normalized nor orthogonal to each other, and the corresponding GS basis functions 422 that are orthonormalized.

Once the orthogonal basis functions are determined, scatter estimate may be pre-calculated as a sum of the products of coefficients a₁, . . . , aₖ and corresponding basis functions pᵢ over all energy bins except the photopeak. The scatter estimate for one dimension (e.g., one scintillation crystal) may be represented as follows:

$$scatter = {\sum }_{{i}_{E}} ( {a}_{1} {p}_{1} ( {i}_{E} ) + {a}_{2} {p}_{2} ( {i}_{E} ) + … ) \qquad ( 7 )$$

Unlike iterative EBS that only finds solutions in which the coefficients a₀, a₁, a₂, etc. are non-negative, the present event-by-event EBS scatter estimation method has no such constraint. The present event-by-event EBS scatter estimation method may determine solutions for both negative and non-negative coefficients. In some cases, for example PET brain scans, the corresponding solution models the scatter more accurately.

The equation for scatter estimate in two dimensions may be as follows:

$$scatter ( d ) = {\sum }_{{i}_{E}} {\sum }_{{k}_{A} {k}_{B}}^{′} {a}_{{k}_{A} {k}_{B}} {p}_{{k}_{A} {k}_{B}} ( {i}_{EA} , {i}_{EB} ; d ) \qquad ( 8 )$$

where Σ′ indicates summation over all indices except k_{A}=0 and k_{B}=0, i.e. a sum of everything except the estimated scatter-free radiation in detector bin d.

To estimate the scatter content with the orthogonal basis functions gₖ, processing module 107 estimates coefficients for each event in the calibration scan data. After the coefficients are determined, processing module 107 determines estimated scatter content values in each PET line of response (LOR) using the coefficients. More particularly, measured values n′ in the calibration scan data may first be copied into a vector \vec{y}ₙ_{_{b}} and then the following recursive procedure is used to determine the coefficients aₖ:

$${a}_{k} = \frac{{\vec{g}}_{k} \cdot {\vec{y}}_{k + 1}}{{\vec{g}}_{k} \cdot {\vec{p}}_{k}} \qquad ( 9 )$$

$${\vec{y}}_{k} = {\vec{y}}_{k + 1} - {a}_{k} {\vec{p}}_{k} \qquad ( 10 )$$

wherein equations (9) and (10) are performed recursively in reverse order, k=n_{b}−1, n_{b}−2, and so on up to k=0.

After coefficients aₖ have been calculated, the scatter estimate is calculated with equation (8). More particularly, the estimate of scatter may be determined by calculating the sum of products of the coefficients a and corresponding basis functions p over energy bins of all terms, as shown in Equation (8). Each vector \vec{y}ₖ indicates how much of the energy spectrum was fitted by the basis kth term in equation (2). The residual vector \vec{y}₀ indicates the discrepancy between the measurement and the model represented by equation (2). The solution is linear because the scatter estimated from the sum of two measurements (say, \vec{n}₁ and \vec{n}₂) equals the scatter estimated from the sum, \vec{n}₁+\vec{n}₂.

The scatter estimate may then be stored in a data structure (e.g., look-up table) for subsequent retrieval. For example, a look-up table may include a 2D array of scatter estimate values (e.g., 54 by 54 array containing 2916 scatter estimate values). When a coincidence event in the coincidence event data has energy signal data values indexed by i_{EA} for the first photon and i_{EB} for the second photon, the corresponding scatter estimate value in the look-up table is retrieved from the look-up table at indices [i_{EA}][i_{EB}]. It should be appreciated that other implementations of the data structure are also possible.

Returning to FIG. 2, at 206, processing module 107 generates a data set (e.g., another set of list mode data) that includes both the coincidence event data and the estimated scatter content. The data set may be generated by sorting the coincidence event data into first and second sinograms. The first sinogram represents the total number of events per bin and the second sinogram represents the estimated scatter content of the bin.

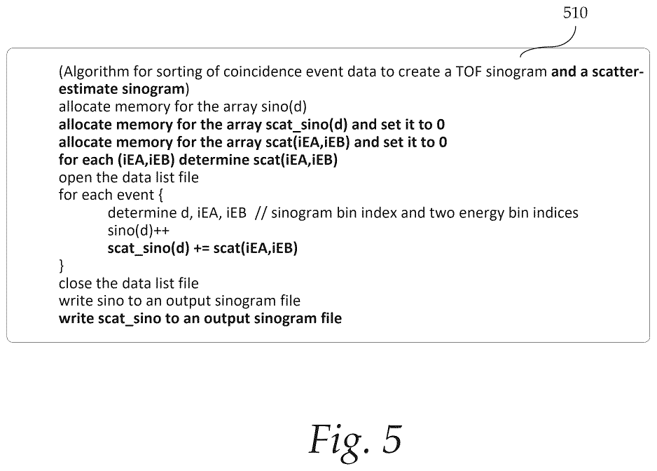

An event-by-event EBS approach may be used to sort the coincidence event data into, for example, a time-of-flight (TOF) sinogram and a scatter estimate sinogram. In this approach, consider the case in which one photon is detected in energy bin(i_{EA},i_{EB}), an array n(i_{EA}, i_{EB}; d) is created with just that one bin set to 1, and all other bins set to 0. To use this approach, we first consider every possible combination of i_{EA} and i_{EB}, using equations (8), (9) and (10) to determine the one-photon scatter estimate for that combination of indices. In one example, since the number of (i_{EA}, i_{EB}) combinations is 54×54=2916, running the algorithm 2916 times creates every possible one-photon scatter estimate. Advantageously, the algorithm needs only be performed just this many times. Event-by-event EBS may be performed when the coincidence event data from the PET scanner is sorted into a sinogram. FIG. 5 shows an exemplary algorithm 510 for sorting the coincidence event data into a time-of-flight (TOF) sinogram and a scatter estimate sinogram.

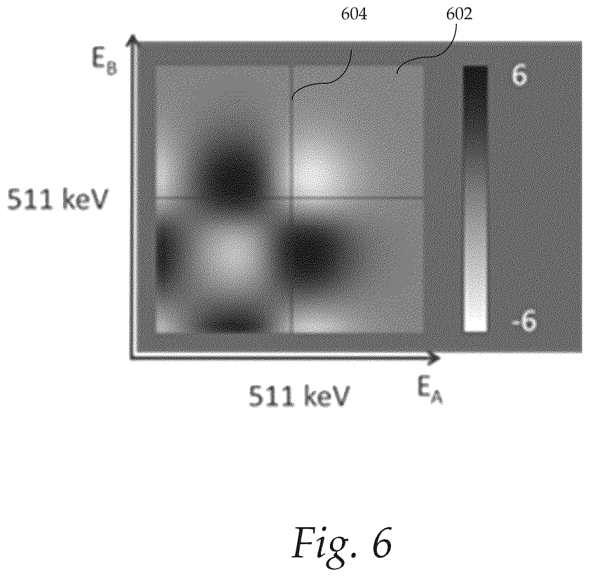

FIG. 6 shows an exemplary grayscale image 602 that represents one-photon scatter estimate values. More particularly, the grayscale image 602 shows the scatter estimate values scat(i_{EA},i_{EB}) based on the basis functions described above in the space of 54×54 energy bins. Values range between −4.67 and +5.52. The mean value was 0.395. Crosshair 604 indicates the bins corresponding to 511 keV, the nominal photopeak energy.

In some implementations, linear spatial filtering is performed on the estimate of scatter content. Linear spatial filtering reduces the variability or noise in the estimate and may include forming a linear combination of scatter estimates in individual lines of response. Spatial filtering of the sinogram array may be performed in various ways. In some implementations, the reconstruction software generates a normalization array, or norm. The norm may be defined for all prompt sinogram bins, and in the case of the delayed sinogram bin, there may be a combination of norm values in the prompt bins. The bin was defined by discrete indices representing radial and axial dimensions, the azimuthal angle, TOF, and the co-polar angle.

The linear filtering equation may be as follows:

$$normalized scatter ( d ) = ( ( s ( d ) - o \times r ( d ) ) \times norm ( d ) ) * filter ( d ) \qquad ( 11 )$$

wherein s(d) is the scatter estimate in the prompt bin, r(d) is the scatter estimate in the corresponding delayed bin, o is a factor that relates the prompt and random bins, x is multiplication, * is convolution, and filter(d) is a convolution kernel. A filter that operates only on the radial, axial and azimuthal dimensions may be used. Although other filters may also be used, the present framework is based on discrete boxcar filters characterized by a spatial distance parameter, Δx.

The kernel's widths in the radial, axial and azimuthal directions are as follows:

$$kernel radial width ( cm ) = Δ x \qquad ( 12 )$$

$$kernel axial width ( cm ) = Δ x \qquad ( 13 )$$

$$kernel azimuthal width ( radians ) = \frac{Δ x}{10 cm} \qquad ( 14 )$$

wherein Δx is a spatial distance parameter. The values in (12), (13) and (14) may be converted to bins and rounded to the nearest odd integer.

Processing module 107 may apply the estimated scatter content in image reconstruction of the coincidence event data. The reconstructed image is an image of the target tissue region in which the estimated scatter content has been removed. In some implementations, the image reconstruction may be performed by subtracting the estimated scatter content from each of the sinogram energy bins in the coincidence event data.

In some implementations, non-attenuation corrected (NAC) PET images are generated by reconstructing the first sinogram by using a scatter estimate determined by filtering the second sinogram. In other implementations, PET/CT reconstruction is performed by reconstructing the first sinogram to generate a positron emission tomographic (PET) image and an attenuation map based on a computed tomographic (CT) image by using a scatter estimate determined by filtering the second sinogram. In yet other implementations, PET/MR reconstruction is performed by reconstructing the first sinogram to generate a positron emission tomographic (PET) image and an attenuation map based on a magnetic resonance (MR) image by using a scatter estimate determined by filtering the second sinogram.

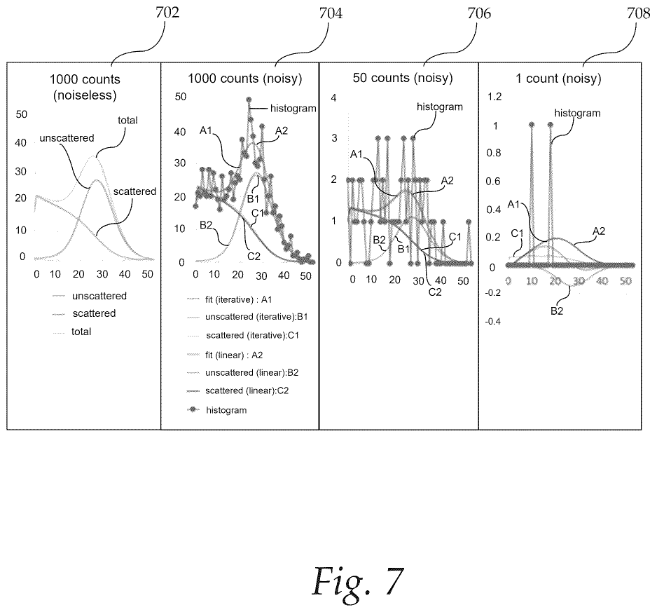

FIG. 7 illustrates results obtained by an exemplary one-dimensional (1D) scatter estimation model. More particularly, graph 702 illustrates a simulated 1D energy spectrum \hat{n}(i_{E}), showing photopeak and scatter components. The horizontal axis represents 54 energy bins, and the vertical axis represents counts per energy bin. The 1D energy spectrum was simulated with 50% scatter content by combining three basis functions.

A pseudo-random-number generator was used to add Poisson noise in cases of 1000, 50 and 1 total counts, resulting in energy spectra n(i_{E}) with 1018, 54 and 2 counts total. Graph 704 illustrates a Monte-Carlo spectrum with 1000 counts, plus noise, which is compared to fitted curves based on traditional iterative EBS and the present fast linear event-by-event EBS. Graph 706 illustrates a Monte-Carlo spectrum with 50 counts plus noise, while graph 708 illustrates a Monte-Carlo spectrum with 1 count plus noise.

Traditional iterative EBS and the present linear event-by-event EBS were used in each case to estimate the coefficients and the scatter content. The expected and estimated amounts of scatter for iterative and linear EBS were: 500, 539, and 525 counts in the case of 1000 total counts; 25, 33.5, and 32.7 counts in the case of 50 total counts; and 0.5, 2.0, and 4.4 counts in the case of just 1 count. Iterative and linear EBS estimated the scatter component with less accuracy as the number of counts decreased. Negative coefficients were seen when linear EBS was used and there were almost no counts in the simulation.

The following is a list of non-limiting illustrative embodiments disclosed herein:

Illustrative embodiment 1. A method of positron emission tomography (PET) scatter estimation, comprising: acquiring coincidence event data of a target region, wherein the coincidence event data records energy signal data associated with scintillation crystals of a PET scanner; and estimating scatter content associated with each coincidence event in the coincidence event data by using the energy signal data.

Illustrative embodiment 2. The method of illustrative embodiment 1 wherein the energy signal data comprises first and second energy signal data corresponding to first and second scintillation crystals of the PET scanner.

Illustrative embodiment 3. The method of any one of illustrative embodiments 1-2 wherein estimating the scatter content comprises extracting the scatter content from a set of scatter content values.

Illustrative embodiment 4. The method of illustrative embodiment 3 wherein the set of scatter content values is stored in a data structure, and estimating the scatter content comprises retrieving the scatter content from the data structure based only on the energy signal data.

Illustrative embodiment 5. The method of illustrative embodiment 3 further comprising pre-calculating the set of scatter content values using orthogonal basis functions.

Illustrative embodiment 6. The method of illustrative embodiment 5 wherein pre-calculating the set of scatter content values comprises determining coefficients for each event and determining the scatter content values based on the coefficients.

Illustrative embodiment 7. The method of any one of illustrative embodiments 1-6 further comprising determining orthogonal basis functions.

Illustrative embodiment 8. The method of illustrative embodiment 7 wherein determining the orthogonal basis functions comprises: acquiring, during a calibration procedure, calibration scan data that records a first energy spectrum of an approximately scatter-free radiation source; modeling a second energy spectrum of scattered radiation as a linear combination of initial basis functions derived from the first energy spectrum; and constructing the orthogonal basis functions from the initial basis functions.

Illustrative embodiment 9. The method of illustrative embodiment 8 wherein at least one of the initial basis functions is directly extracted from the first energy spectrum.

Illustrative embodiment 10. The method of illustrative embodiment 8 wherein at least one of the initial basis functions is derived by determining a smooth function that closely fits the first energy spectrum.

Illustrative embodiment 11. The method of illustrative embodiment 8 wherein at least one of the initial basis functions are derived by determining a cross-correlation of a simplified basis function with the first energy spectrum.

Illustrative embodiment 12. The method of illustrative embodiment 8 wherein constructing the orthogonal basis functions from the initial basis functions comprises performing Gram-Schmidt orthogonalization.

Illustrative embodiment 13. The method of any one of illustrative embodiments 1-12 further comprising performing linear filtering on the estimated scatter content.

Illustrative embodiment 14. The method of any one of illustrative embodiments 1-13 further comprising generating a data set that includes both the coincidence event data and the estimated scatter content.

Illustrative embodiment 15. The method of illustrative embodiment 14 wherein generating the data set comprises: sorting the coincidence event data into first and second sinograms, wherein the first sinogram represents a total number of events per bin and the second sinogram represents the estimated scatter content of the bin.

Illustrative embodiment 16. The method of illustrative embodiment 15 further comprising: reconstructing the first sinogram to generate a positron emission tomographic (PET) image by using a scatter estimate determined by filtering the second sinogram.

Illustrative embodiment 17. The method of illustrative embodiment 15 further comprising: reconstructing the first sinogram to generate a positron emission tomographic (PET) image and an attenuation map based on a computed tomographic (CT) image by using a scatter estimate determined by filtering the second sinogram.

Illustrative embodiment 18. The method of illustrative embodiment 15 further comprising: reconstructing the first sinogram to generate a positron emission tomographic (PET) image and an attenuation map based on a magnetic resonance (MR) image by using a scatter estimate determined by filtering the second sinogram.

Illustrative embodiment 19. One or more non-transitory computer readable media embodying a program of instructions executable by machine to perform steps comprising: acquiring coincidence event data of a target region, wherein the coincidence event data records energy signal data associated with scintillation crystals of a PET scanner; and estimating scatter content associated with each coincidence event in the coincidence event data by using the energy signal data.

Illustrative embodiment 20. A positron emission tomography (PET) scatter estimation system, comprising: a non-transitory memory device for storing computer readable program code; and a processor device in communication with the non-transitory memory device, the processor device being operative with the computer readable program code to perform steps including acquiring coincidence event data of a target region, wherein the coincidence event data records energy signal data associated with scintillation crystals of a PET scanner, and estimating scatter content associated with each coincidence event in the coincidence event data by using the energy signal data.

While the present framework has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

What is claimed is:

1. A method of positron emission tomography (PET) scatter estimation, comprising:
acquiring coincidence event data of a target region, wherein the coincidence event data records energy signal data associated with scintillation crystals of a PET scanner; and
estimating scatter content associated with each coincidence event in the coincidence event data by using the energy signal data.

2. The method of claim 1 wherein the energy signal data comprises first and second energy signal data corresponding to first and second scintillation crystals of the PET scanner.

3. The method of claim 1 wherein estimating the scatter content comprises extracting the scatter content from a set of scatter content values.

4. The method of claim 3 wherein the set of scatter content values is stored in a data structure, and estimating the scatter content comprises retrieving the scatter content from the data structure based only on the energy signal data.

5. The method of claim 3 further comprising pre-calculating the set of scatter content values using orthogonal basis functions.

6. The method of claim 5 wherein pre-calculating the set of scatter content values comprises determining coefficients for each event and determining the scatter content values based on the coefficients.

7. The method of claim 1 further comprising determining orthogonal basis functions.

8. The method of claim 7 wherein determining the orthogonal basis functions comprises:
acquiring, during a calibration procedure, calibration scan data that records a first energy spectrum of an approximately scatter-free radiation source;
modeling a second energy spectrum of scattered radiation as a linear combination of initial basis functions derived from the first energy spectrum; and
constructing the orthogonal basis functions from the initial basis functions.

9. The method of claim 8 wherein at least one of the initial basis functions is directly extracted from the first energy spectrum.

10. The method of claim 8 wherein at least one of the initial basis functions is derived by determining a smooth function that closely fits the first energy spectrum.

11. The method of claim 8 wherein at least one of the initial basis functions are derived by determining a cross-correlation of a simplified basis function with the first energy spectrum.

12. The method of claim 8 wherein constructing the orthogonal basis functions from the initial basis functions comprises performing Gram-Schmidt orthogonalization.

13. The method of claim 1 further comprising performing linear filtering on the estimated scatter content.

14. The method of claim 1 further comprising generating a data set that includes both the coincidence event data and the estimated scatter content.

15. The method of claim 14 wherein generating the data set comprises:
sorting the coincidence event data into first and second sinograms, wherein the first sinogram represents a total number of events per bin and the second sinogram represents the estimated scatter content of the bin.

16. The method of claim 15 further comprising:
reconstructing the first sinogram to generate a positron emission tomographic (PET) image by using a scatter estimate determined by filtering the second sinogram.

17. The method of claim 15 further comprising:
reconstructing the first sinogram to generate a positron emission tomographic (PET) image and an attenuation map based on a computed tomographic (CT) image by using a scatter estimate determined by filtering the second sinogram.

18. The method of claim 15 further comprising:
reconstructing the first sinogram to generate a positron emission tomographic (PET) image and an attenuation map based on a magnetic resonance (MR) image by using a scatter estimate determined by filtering the second sinogram.

19. One or more non-transitory computer readable media embodying a program of instructions executable by machine to perform steps comprising:
acquiring coincidence event data of a target region, wherein the coincidence event data records energy signal data associated with scintillation crystals of a PET scanner; and
estimating scatter content associated with each coincidence event in the coincidence event data by using the energy signal data.

20. A positron emission tomography (PET) scatter estimation system, comprising:
a non-transitory memory device for storing computer readable program code; and
a processor device in communication with the non-transitory memory device, the processor device being operative with the computer readable program code to perform steps including
acquiring coincidence event data of a target region, wherein the coincidence event data records energy signal data associated with scintillation crystals of a PET scanner, and
estimating scatter content associated with each coincidence event in the coincidence event data by using the energy signal data.
